(19) United States
(12) Patent Application Publication
(10) Pub. No.: US 2009/0045953 A1
(43) Pub. Date: Feb. 19, 2009

(54) METHOD AND SYSTEM FOR MONITORING PROTECTED OBJECTS AND ALARMING WHEN THE POSITION THEREOF IS MODIFIED

(76) Inventor: Vitaly Petrovich Lenshin, Moscow (RU)

Correspondence Address: PATENTTM.US, P. O. BOX 82788, PORTLAND, OR, 97282-0788, US

(21) Appl. No.: 12/089,977

(22) PCT Filed: Oct. 13, 2006
(86) PCT No.: PCT/RU06/00531

§ 371 Date: Apr. 11, 2008

(30) Foreign Application Priority Data
Nov. 9, 2005 (RU) 2005134666

(51) Int. Cl. G08B 13/14

(52) U.S. Cl. 340/568.1

(57) ABSTRACT

The method consists in mounting a first transmitter on a first protected object and a second transmitter on a second protected object and in generating an alarm signal by a user's receiver when one of transmitters moves away therefrom, in additionally introducing a receiver/transmitted, in arranging the user's receiver on the first protected object, in generating an alarm signal by the receiver/transmitted, according to the signal of the first transmitter, when the first protected object provided with the user's receiver moves away therefrom and in generating an alarm signal by the user's receiver according to the signal of the transmitter of the receiver/transmitted, when said receiver/transmitted moves away therefrom. In the inventive system, the user's receiver is mounted on the first protected object and the receiver/transmitted is mounted on the second protected object.

### FIELD OF THE INVENTION

This invention relates to a method and a device for an alarm system and may be used for warning about changes in locations of monitored objects relative to a user monitoring them.

### PRIOR ART

Methods of monitoring and warning about changes in status of a protected object are known, according to which local stations generate protected object interrogation signals and a central station collects data on protected objects (U.S. Pat. No. 4,742,335), (RU, A, 2183352).

These technical solutions are used for a variety of applications: in fire alarm systems, antitheft alarm systems, alarm systems, burglar alarm systems, monitoring systems, etc.

A limitation of these systems is their complexity, and they cannot be used in practice for protecting personal belongings carried by a person.

This application is a continuation-in-part of the earlier RF application No. 2003105521 “Alarm System device” (RU, A, 2234135). This known device implements a method enabling to protect personal belongings carried by a user against theft, for example, to protect an ID card, a purse, a note-book, an organizer, a cellular phone, etc.

A known method of monitoring and warning about changes in location of a protected object includes, at least, mounting a first transmitter on a first protected object and a second transmitter on a second protected object, generating an alarm signal by a user's receiver when the first or, respectively, the second protected object moves away from the user's received to a distance set by the user (RU, A, 2234135).

A system of monitoring and warning about changes in location of protected objects is also known, which comprises, at least, a first transmitter installed on a first protected object, a second transmitter installed on a second protected object, a user's receiver made capable of generating an alarm signal when one of the transmitters moves away from it (RU, A, 2234135).

This system provides for generating a sound or vibration signal by a user's receiver in his pocket when, for example, an ID card, on which a miniature radio transmitter is installed, moves away from the user's receiver to a preset distance (e.g., to 1 meter). This system, when implemented, enables to timely warn its user about possible loss (or theft) of protected objects—valuable personal belongings, including those having rather small dimensions. It is expedient that the user's receiver in this system should be miniature in order not to be too heavy for the user. In essence, a receiver in the technical solution performs the function of the central station warning the user and registering movement of his personal belonging away.

The limitation of the known method and the known device is their insufficiently high overall reliability in protecting personal belongings, because the very user's receiver—the central node of the system—may be lost or stolen. Also, it would be desirable that higher reliability would not result in sharp increase in dimensions and weight of the system.

### BRIEF DESCRIPTION OF THE INVENTION

The objective, forming the basis of this invention, is to create a method of monitoring and warning about changes in locations of protected objects, which would exclude any possibility of losing a receiver, and develop a system for monitoring and warning about changes in locations of protected objects, which, at insignificant increases in dimensions and weight of the whole system, ensures the possibility of observing locations of two and more protected objects of its user, including a receiver, and, thus, improve its reliability and expand its functional capabilities.

In order to attain this objective and achieve the above technical effect it is proposed to introduce, according to this invention, into the known method of monitoring and warning about changes in locations of protected objects, including, at least, installing a first transmitter on a first protected object and a second transmitter on a second protected object, generating an alarm signal by a user's receiver when one of the transmitters moves away from it, a receiver-transmitter, to install the user's receiver on a first protected object, wherein the receiver-transmitter generates an alarm signal when the first protected object with the receiver moves away from it, and the user's receiver generates an alarm signal upon receipt of a signal from the receiver of the receiver-transmitter when the latter moves away from it.

Additional embodiments of the method are possible, wherein it is appropriate that:
the receiver-transmitter is installed on the second protected object, the said second transmitter is used as the transmitter of the receiver-transmitter, the user's receiver generates an alarm signal upon receipt a signal from the second transmitter when the second protected object moves away from it;
the receiver of the receiver-transmitter is made identical to the user's receiver by its specifications;
the user's receiver and/or the receiver-transmitter is made so as to ensure generating an alarm signal when the respective protected object moves away to a distance pre-set by the user by pre-adjustment of the power level of the first transmitter and/or the transmitter of the receiver-transmitter, accordingly, or by pre-adjustment of the threshold level of activating the user's receiver and/or the receiver of the receiver-transmitter;
additional transmitters are introduced, which are installed on additional protected objects, wherein both the user's receiver and the receiver-transmitter generate alarm signals when additional protected objects move away from them.

In order to solve the stated task and achieve the stated technical effect it is proposed to introduce, according to this invention, into the known system for monitoring and warning about changes in locations of protected objects, which comprises, at least, a first transmitter installed on a first protected object, a second transmitter installed on a second protected object, a user's receiver made capable of generating an alarm signal when one of the transmitters moves away from it, a receiver-transmitter wherein the said second transmitter is used as the transmitter of the receiver-transmitter, the user's receiver is installed on a first protected object and the receiver-transmitter is installed on a second protected object, the receiver transmitter being made capable of generating an alarm signal when the first protected object moves away from it, and the user's receiver is made capable of generating an alarm signal when the second protected object moves away from it.

Additional embodiments of the system are possible, wherein it is appropriate that:
the user's receiver and the first transmitter are made in a single case;
the receiver and the transmitter of the receiver-transmitter are made in a single case.

The stated advantages as well as the specific features of this invention will be further explained in the description of preferred embodiments with reference to the appended drawings.

### BRIEF DESCRIPTION OF THE DRAWINGS

FIG. 1 shows the claimed system in a variant wherein a receiver-transmitter is installed on a protected object;

FIG. 2—same as FIG. 1, in a variant wherein a receiver-transmitter is not installed on a protected object.

### DESCRIPTION OF PREFERRED EMBODIMENTS

Since the claimed method is realized at the functioning system, its characteristics and possible advantages are given in the description of the system operation.

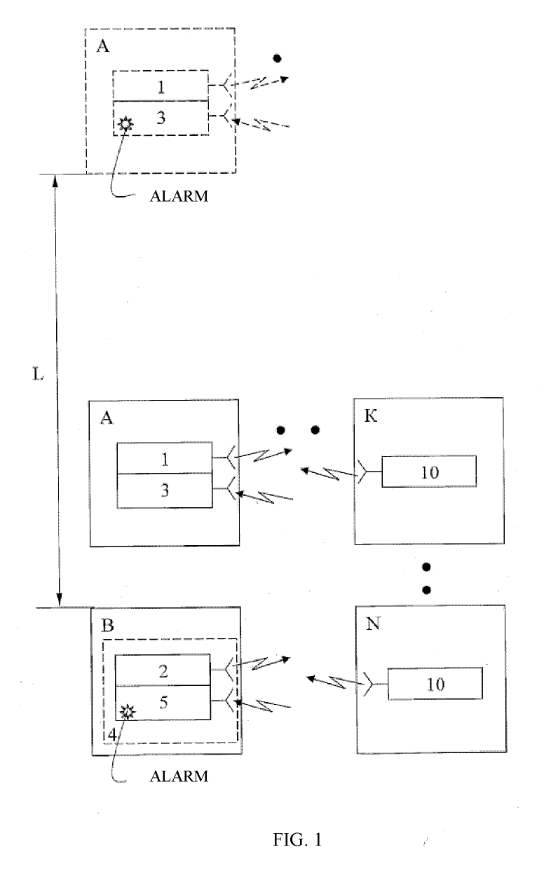

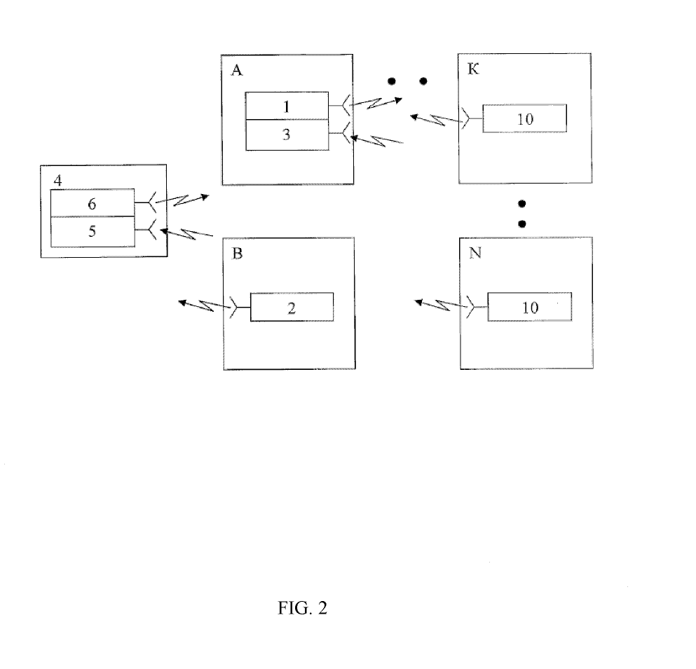

A system for monitoring and warning about changes in locations of protected objects (FIG. 1) comprises at least a first transmitter 1 installed on a first protected object A, and a second transmitter 2 installed on a second protected object B. A user's receiver 3 is made capable of generating an alarm signal when one of the transmitters moves away from it. The system also comprises a receiver-transmitter 4 introduced therein, which comprises a receiver 5. As the receiver of the receiver-transmitter 4 the said second transmitter 2 or its own transmitter 6 (FIG. 2) may be used. The user's receiver 3 is installed on a first protected object A, and the receiver-transmitter 4 is installed on a second protected object B. The receiver-transmitter 4 is made capable of generating an alarm signal when a first protected object A moves away from it, and the user's receiver 3 is made capable of generating an alarm signal when a second protected object B moves away from it, e.g., to a distance L (FIG. 1).

The second variant of the system (FIG. 2) differs from the first variant (FIG. 1) only in that at the user's will the receiver-transmitter 4 is not installed on a protected object, for example, on the protected object B, and the protected object B is monitored by receiving by the receiver-transmitter 4 radio signals sent by its own second transmitter 2 installed on the object B.

In order to reduce dimensions and weight of the system (since a user carries personal belongings, i.e., protected objects A and B, with him) it is appropriate that the user's receiver 3 and the first transmitter 1 are made in a single case, and the receiver 5 of the receiver-transmitter 4 and the transmitter 6 of the receiver-transmitter (FIG. 2) are made in a single case.

Thus, the method of monitoring and warning about changes in locations of protected objects A and B includes, in general (FIG. 2):
installing the first transmitter 1 on a first protected object A and the second transmitter 2 on a second protected object B;
generating an alarm signal by the user's receiver 3 when one of the transmitters moves away from it;
introducing the receiver-transmitter 4 into the system;
installing the user's receiver 3 on a first protected object A;
generating an alarm signal by the receiver-transmitter 4 upon receipt of a signal from the first transmitter 1 when the first protected object A with the user's receiver 3 moves away from it;
generating an alarm signal by the user's receiver 3 upon receipt of a signal from the transmitter 6 of the receiver-transmitter 4 when the receiver-transmitter 4 moves away from it.

If the receiver-transmitter 4 is installed on a second protected object B (FIG. 1), then the second transmitter 2 is used as the transmitter of the receiver-transmitter 4, and upon receipt of a signal from the second transmitter 2 the user's receiver 3 generates an alarm signal when a second protected object B moves away from it. This variant may be used in order not to carry supposedly “excess” thing—the receiver-transmitter 4—in a user's pocket, while using it for protecting not only the user's receiver 3, but also any valuable thing of the user. This variant enables to further reduce the dimensions of the whole system. But it would be understood by those skilled in the art that a variant introducing a separate receiver-transmitter 4 (FIG. 2) is not aimed at simply backing up the user's receiver 3, since it enables to simultaneously monitor all protected objects A, B . . . N, as well as the receiver 3 and the receiver-transmitter 4. Thus, actually, operation reliability of the method and the system is improved.

The system may be expanded by additional receivers 10 to be installed on additional protected objects K . . . N (FIGS. 1, 2). In this case the protection reliability for all personal belongings of a user is also improved, since both the user's receiver 3 and the receiver-transmitter 4 generate alarm signals when additional protected objects K . . . N move away from them. For example, if a sound or vibration alarm signal from any of them is not receiver by the user's receiver 3, it will be monitored by the receiver-transmitter 4, since the user carries both the receiver 3 and the receiver-transmitter 4 (and both may be installed on a personal belonging of the user). Thus, the functionality is expanded by receipt and processing t signals from additional protected objects K . . . N.

Also, the functionality is expanded when the receiver 3 moves away from the receiver-transmitter 4 (FIG. 1) to a distance L.

Indeed, in such a case an alarm signal will be simultaneously sound both in the user's receiver 3 and in the receiver 5 of the receiver-transmitter 4. So, in a case of losing one or another it would be easy to determine its location by an alarm signal and find it.

The receiver 5 of the receiver-transmitter 4 may be made identical to the user's receiver 3 as to its specifications. In such a case, when the receiver 3 moves away to a distance L (FIG. 1), the receiver-transmitter 4 generates an alarm signal as in the case of protected objects K . . . N provided with transmitters 10 only. It will be understood by those skilled in the art that no activation of the receiver 3 by a signal from the associated transmitter 1 or the receiver 5 of the receiver-transmitter 4 by a signal from the associated transmitter 2 or 6 takes place, since they, in relation to each other, are not at any activation distance for sending an alarm signal by a signal of the associated transmitter.

Similarly to the closest analogous solution, the user's receiver 3 and/or the receiver-transmitter 4 is made so as to ensure generation of an alarm signal when a respective protected object A, B, . . . K . . . N moves away to a distance L pre-set by a user by pre-adjusting the power level of the first transmitter 1 and/or the transmitter 2 or 6 of the receiver-transmitter 4, respectively (as well as additional transmitters 10) or by pre-adjusting the threshold level for activating the user's receiver 3 and/or the receiver 5 of the receiver-transmitter 4.

Similarly to the closest analogous solution, a signal generated by each of the transmitters may be provided with a code, which enables, after processing a coded signal by the respective receiver, to determine what of protected objects A, B, . . . K . . . N is under the risk of loss. The protection of only two personal belongings—protected objects A and B (FIG. 1)—is possible, in such a case receivers-transmitters should be installed directly on them.

Improved reliability of protection should be suitable for owners of especially valuable things, e.g., official documents, ID cards, etc. as well as for a general users for protecting their personal belongings, e.g., cellular phones, ID cards, purses, valuables (ladies' decorations), etc. The claimed invention ensures a full protection system for one's own carried property both against accidental loss and against theft.

### INDUSTRIAL APPLICABILITY

The claimed method and system for monitoring and warning about changes in locations of protected objects may be most successfully applied in radio alarm systems used for monitoring locations of personal belongings.

What is claimed is:

1. A method of monitoring and warning about changes in locations of protected objects, including, at least, installing a first transmitter on a first protected object and a second transmitter on a second protected object, generating an alarm signal by a user's receiver when one of the transmitters moves away from it, characterized in that a receiver-transmitter is introduced, the user's receiver is installed on a first protected object, an alarm signal being generated by the receiver-transmitter upon receipt of an alarm signal from the first transmitter when the first protected object with the user's receiver moves away from it, and an alarm signal being generated by the user's receiver upon receipt of an alarm signal from the transmitter of the receiver-transmitter when the latter moves away from it.

2. A method according to claim 1, characterized in that a receiver-transmitter is installed on a second protected object, said second transmitter is used as the transmitter of the receiver-transmitter, the user's receiver generates an alarm signal upon receipt of a signal from the second transmitter when a second protected object moves away from it.

3. A method according to claim 1, characterized in that the receiver of the receiver-transmitter is made identical to the user's receiver as to its specifications.

4. A method according to claim 1, characterized in that the user's receiver and/or the receiver-transmitter is made capable of generating an alarm signal when a respective protected object moves away to a distance pre-set by the user by pre-adjusting the power level of the first transmitter and/or the transmitter of the receiver-transmitter, respectively, or by adjusting the threshold level of activating the user's receiver and/or the receiver of the receiver-transmitter.

5. A method according to claim 1, characterized in that additional transmitters are introduced, which are installed on additional protected objects, wherein both the user's receiver and the receiver-transmitter generate alarm signals when additional protected objects move away from them.

6. A system for monitoring and warning about changes in locations of protected objects, comprising, at least, a first transmitter installed on a first protected object, a second transmitter installed on a second protected object, a user's receiver made capable of generating an alarm signal when one of said transmitters moves away from it, characterized in that a receiver-transmitter is introduced into it, wherein said second transmitter is used as the transmitter of the receiver-transmitter, the user's receiver is installed on the first protected object, and the receiver-transmitter is installed on the second protected object, the receiver-transmitter being made capable of generating an alarm signal when the first protected object moves away from it, and the user's receiver being made capable of generating an alarm signal when the second protected object moves away from it.

7. A system according to claim 6, characterized in that the user's receiver and the first transmitter are made in a single case.

8. A system according to claim 6, characterized in that the receiver and the transmitter of the receiver-transmitter are made in a single case.
